(19) United States
(12) Patent Application Publication
(10) Pub. No.: US 2010/0106745 A1
(43) Pub. Date: Apr. 29, 2010

(54) METHOD AND APPARATUS FOR GENERATING FINGERPRINT DATABASE FOR WIRELESS LOCATION

(75) Inventors: Seong Yun CHO, Daejeon (KR); Byung Doo Kim, Daejeon (KR); Youngsu Cho, Seoul (KR); Sung Jo Yun, Daejeon (KR); Sun-Joong Kim, Daejeon (KR); Wan Sik Choi, Daejeon (KR); Jong-Hyun Park, Daejeon (KR)

Correspondence Address: Jae Y. Park, Kile, Goekjian, Reed & McManus, PLLC, 1200 New Hampshire Ave. NW, Suite 570, Washington, DC, 20036, US

(73) Assignee: ELECTRONICS AND TELECOMMUNICATIONS RESEARCH INSTITUTE, Daejeon (KR)

(21) Appl. No.: 12/535,657

(22) Filed: Aug. 4, 2009

(30) Foreign Application Priority Data
Oct. 23, 2008 (KR) 10-2008-0104140
Dec. 11, 2008 (KR) 10-2008-0126104

(51) Int. Cl. G06F 17/30

(52) U.S. Cl. 707/802; 707/E17.044

(57) ABSTRACT

Provided is a fingerprint database generating method and device for wireless location. Signal strength is estimated by using access points on a numerical map, position coordinates of grid points, and a radio wave attenuation model so as to generate a fingerprint database. A simulation error is computed based on actual survey data measured in the real space, and the estimated signal strength is corrected by using the computed simulation error to thus generate a fingerprint database.

### CROSS-REFERENCE TO RELATED APPLICATION

This application claims priority to and the benefit of Korean Patent Application No. 10-2008-0104140 filed in the Korean Intellectual Property Office on Oct. 23, 2008, and No. 10-2008-0126104 filed in the Korean Intellectual Property Office on Dec. 11, 2008, the entire contents of which are incorporated herein by reference.

### BACKGROUND OF THE INVENTION

(a) Field of the Invention

The present invention relates to a method and device for generating a fingerprint database for wireless location.

(b) Description of the Related Art

In general, a telematics/local based service (LBS) navigation system is configured by using a receiver for a satellite-based positioning system such as the global position system (GPS). For example, the navigation system provides services such as path guidance and local information by using vehicle location information acquired through a GPS receiver. The GPS receiver has the problem of failing to provide position information because of weak satellite signals in a room, tunnel, underground parking lot, and urban areas.

Accordingly, interior location capacities have been actively researched so as to provide various interior position-based services, and particularly, the wireless location schemes using wireless communication devices such as the wireless local area network (WLAN), the ultra wide band (UWB), the chirp spread spectrum (CSS), the Zigbee, and the Bluetooth have been researched. However, in the case of performing interior location by using the wireless communication device, it is difficult to acquire position information with great accuracy because of the short distance between the access point (AP) and the terminal, multipath error caused by walls or furniture, and signal attenuation.

The general method for performing the wireless location includes the trilateration method for computing the position of the terminal by measuring or estimating the distance between the AP and the terminal, and the fingerprint scheme for position recognition. The fingerprint method provides good performance in an environment with many non-lines-of-sight (NLOS).

In order to perform the wireless location by using the fingerprint capacity, is a database needs to be generated in advance, and the method for using actual survey data has been generally used to build the database. However, much time and manpower is required so as to build the database by using actual survey data, and when the internal structure for the location for performing the wireless location is modified, additional time and manpower have been needed to newly build the database, which is difficult to be realized.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and device for generating a fingerprint database for wireless location which is easy to build.

An exemplary embodiment of the present invention provides a fingerprint database generating device for wireless location, including: a signal strength database generator for estimating signal strength of a signal received from at least one access point disposed on a numerical map for each grid point; an actual survey data acquirer for acquiring actual survey signal strength measured from at least one point of a real space corresponding to the numerical map; an error database generator for computing a simulation error by using the actual survey signal strength; and an error corrector for generating a fingerprint database by correcting the signal strength estimated per grid point by using the simulation error.

Another embodiment of the present invention provides a fingerprint database generating method for wireless location, including: setting a plurality of grid points on a numerical map corresponding to a real space for performing wireless location, and disposing at least one access point on the numerical map; estimating signal strength of the signal received from the at least one access point for each of the plurality of grid points; acquiring actual survey signal strength measured from at least one point of the real space corresponding to the numerical map; computing a simulation error by using the actual survey signal strength; and correcting the signal strength estimated per each of the plurality of grid points by using the simulation error.

### BRIEF DESCRIPTION OF THE DRAWINGS

FIG. 1 shows a configuration diagram of a fingerprint DB generating device according to an exemplary embodiment of the present invention.

FIG. 2 shows a flowchart of a fingerprint DB generating method according to an exemplary embodiment of the present invention.

FIG. 3 shows a numerical map on which a GP and an AP according to an exemplary embodiment of the present invention are set.

FIG. 4 shows an example of per-GP signal strength displayed on a numerical map with color according to an exemplary embodiment of the present invention.

FIG. 5 shows an example of an RP according to an exemplary embodiment of the present invention indicated on a numerical map.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

A fingerprint database (DB) generating method and device for wireless location according to an exemplary embodiment of the present invention will now be described with reference to drawings.

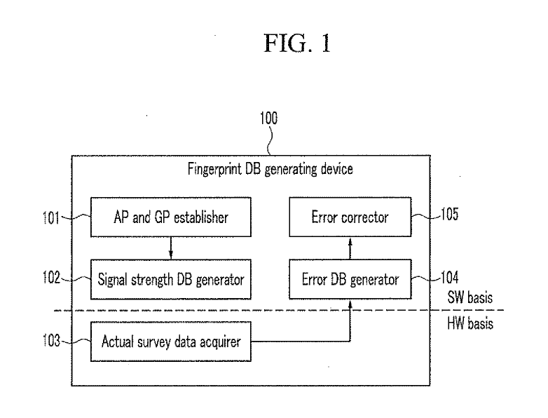

FIG. 1 shows a configuration diagram of a fingerprint DB generating device according to an exemplary embodiment of the present invention.

Referring to FIG. 1, the fingerprint DB generating device 100 includes an AP and grid point (GP) establisher 101, a signal strength DB generator 102, an actual survey data acquirer 103, an error DB generator 104, and an error corrector 105. Here, the AP and GP establisher 101, the signal strength DB generator 102, the error DB generator 104, and the error corrector 105 can be realized with software (SW), and the actual survey data acquirer 103 can be realized with hardware.

The AP and GP establisher 101 sets a plurality of GP's on a numerical map and disposes the AP on the numerical map. Here, the numerical map has a file format allowing storing/reading/writing, and sets the position coordinates (horizontal position coordinate and vertical position coordinate) of each AP. Also, each GP represents a point that is set in the form of lattices with regular intervals on the numerical map, and it corresponds to crossing positions of the lattices on the numerical map.

The signal strength DB generator 102 estimates the received signal strength of the signal output by each AP disposed on the numerical map for each GP on the numerical map. That is, it estimates the signal strength of the signal output by each AP for each GP. For this, the signal strength DB generator 102 uses the numerical map, the AP and GP position coordinates, and an attenuation model.

A signal output by a specific AP is attenuated by the wall and furniture in the room, and each GP receives the attenuated signal. The signal attenuation can be estimated by using the ray-tracing or radio wave attenuation model. Therefore, the signal strength of the signal received from each AP for each GP can be estimated by using the radio wave attenuation model. The signal strength DB generator 102 generates the estimated per-GP signal strength and the corresponding GP's position coordinates into a DB, stores it, and controls it. That is, the signal strength DB generator 102 matches information (AP number and MAC address) for each AP, information (GP number and position coordinates) for each GP, and computed per-GP signal strength to generate them as a DB.

The per-GP signal strength generated into the DB can include a simulation error since it is difficult to accurately detect the signal attenuation characteristic generated by the signal output by the AP because of the wall and furniture when the output signal generates transmission, reflection, refraction, and diffusion. The simulation error is generated depending on the GP's position and the distance between the AP and the GP. Therefore, in order to generate a fingerprint DB used for the actual wireless location, it is needed to correct the simulation error from the per-GP signal strength.

The actual survey data acquirer 103 measures the real signal strength in the real space corresponding to the numerical map by using signal strength measurement equipment. For this, the actual survey data acquirer 103 must be able to accurately check the position coordinates of the position for acquiring the actual survey signal strength. That is, the actual survey data acquirer 103 selects the position coordinates of the position (i.e., reference Point (RP)) for acquiring the actual survey signal strength through position estimation and measurement. The RP can compares and acquire the position coordinates of the thing (wall or furniture) in the real space, and the minimum RP's are disposed in the real space in the exemplary embodiment of the present invention.

When the RP is determined, the actual survey data acquirer 103 acquires the signal strength of the signal received from each AP for each RP through the signal strength measurement equipment. Here, the signal strength measurement equipment includes radio frequency (RF) signal measurement equipment (e.g., signal analyzer) and AP signal scanning (SW).

The actual survey data acquirer 103 acquires many measurement values for each RP through repeated measurement using the signal strength measurement equipment, filters the acquired measurement values (e.g., by using a low pass filter), and acquires the signal strength of the signal received from each AP from the corresponding RP. It makes the acquired actual survey signal strength (per-RP signal strength) and the corresponding RP's position coordinates into a DB, stores the same, and controls the same.

The error DB generator 104 estimates the simulation error included in the per-GP signal strength estimated by the signal strength DB generator 102 by using the actual survey signal strength acquired from the actual survey data acquirer 103, and makes the estimate into a DB.

To estimate the simulation error, the radio wave attenuation model as shown in Equation 1 is required.

\tilde{S}^{I}(P)=S^{I}(P)+δS^{I}(P)+v^{I}(P) (Equation 1)

Here, \tilde{S}^{I} represents signal strength at the point (P=[x y]^{T}) distant from a specific AP(I) by r and includes a signal such as the NLOS. Also, S^{I}(P) represents signal strength estimated by the signal strength DB generator 102 by using the ray-tracing or the radio wave attenuation model, and v^{I}(P) indicates an error including white noise and has a small value.

Further, δS^{I}(P) represents a simlation error, and can be expressed as Equation 2.

E[δS^{I}(P)]=z^{I}(P) (Equation 2)

Here, z^{I}(P) shows a position dependent trend, and it can be modeled as Equation 3.

z^{I}(P)=h^{I}(P)χ^{I}+δ^{I}(P) (Equation 3)

Here, it is given that h^{I}(P)=[1 x y r^{I}], χ^{I}=[χ₀^{I} χ₁^{I} χ₂^{I} χ₃^{I}]^{T}, r^{I}=\sqrt{(x−x^{I})²+(y−y^{I})²}. Also, (x^{I}, y^{I}) represents the position coordinates of AP(I), and E[δ^{I}(P)]=0. In the exemplary embodiment of the present invention, it is possible to model the trend of z^{I}(P) in another way differing from Equation 3.

Equation 4 is expressed by extending Equation 3 with respect to n points (P₁−Pₙ).

$${Z}^{I} = {H}^{I} {χ}^{I} + {D}^{I} \\ Here \\ {Z}^{I} = [ \begin{matrix}{z}^{I} ( {P}_{1} ) \\ ⋮ \\ {z}^{I} ( {P}_{n} )\end{matrix} ] , {H}^{I} = [ \begin{matrix}{h}^{I} ( {P}_{1} ) \\ ⋮ \\ {h}^{I} ( {P}_{n} )\end{matrix} ] , {D}^{I} = [ \begin{matrix}{δ}^{I} ( {P}_{1} ) \\ ⋮ \\ {δ}^{I} ( {P}_{n} )\end{matrix} ] . \qquad ( Equation 4 )$$

Further, X^{I} can be estimated as Equation 5 by using the weighted least squares method so as to determine the trend of the simulation error in the established space.

\hat{χ}^{I}=((H^{I})^{T}W^{I}H^{I})^{31 1}(H^{I})_{T}W^{I}Z^{I} (Equation 5)

Here, Z^{I} is computed through the difference between the actual survey signal strength acquired by the actual survey data acquirer 103 and the estimated signal strength acquired by the signal strength DB generator 102. Further, W^{I} can be configured with the weight value in various ways.

Equation 6 exemplifies generation of the weight value (W^{I}), showing the case of generating the weight value by using a variogram.

$${W}^{I} = {[ \begin{matrix}{γ}^{I} ( {P}_{1} , {P}_{1} ) & {γ}^{I} ( {P}_{1} , {P}_{2} ) & … & {γ}^{I} ( {P}_{1} , {P}_{n} ) \\ {γ}^{I} ( {P}_{2} , {P}_{1} ) & {γ}^{I} ( {P}_{2} , {P}_{2} ) & … & {γ}^{I} ( {P}_{2} , {P}_{n} ) \\ ⋮ & ⋮ & ⋱ & ⋮ \\ {γ}^{I} ( {P}_{n} , {P}_{1} ) & {γ}^{I} ( {P}_{n} , {P}_{2} ) & … & {γ}^{I} ( {P}_{n} , {P}_{n} )\end{matrix} ]}^{- 1} \qquad ( Equation 6 )$$

Here,

$${γ}^{I} ( {P}_{i} , {P}_{j} ) = \frac{1}{2} Var [ {δ}^{I} ( {P}_{i} ) - {δ}^{I} ( {P}_{j} ) ]$$

is a semivariogram. In addition, it is possible in the exemplary embodiment of the present invention to produce the weight value (W^{I}) by using the inverse distance weighting (IDW) method.

Per-GP simulation error (δS^{I}(Pₐ)) can be generated as Equation 7 by using Equations 2 to 6.

δŜ^{I}(Pₐ)=h^{I}(Pₐ)\hat{x}^{I}+(wₐ^{I})^{T}W^{I}[Z^{I}−H^{I}\hat{χ}^{I}] (Equation 7)

Here, wₐ^{I}=[γ^{I}(Pₐ, P₁) γ^{I}(Pₐ, P₂) . . . γ^{I}(Pₐ, Pₙ)]^{T}.

When the simulation error corresponding to each AP for each GP is computed, the error DB generator 104 makes the simulation error into a DB, stores it, and controls it.

The error corrector 105 corrects the per-GP signal strength estimated by the signal strength DB generator 102 by using the per-GP simulation error acquired by the error DB generator 104 based on Equation 1. That is, it finally computes the signal strength of each point by using the sum of the signal strength estimated by the signal strength DB generator 102 and the simulation errors acquired by the error DB generator 104, and generates a fingerprint database by using the computed signal strength.

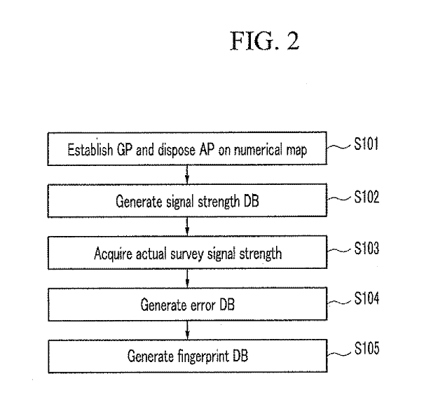

Referring to FIG. 2 to FIG. 5, a fingerprint DB generating method according to an exemplary embodiment of the present invention will now be described.

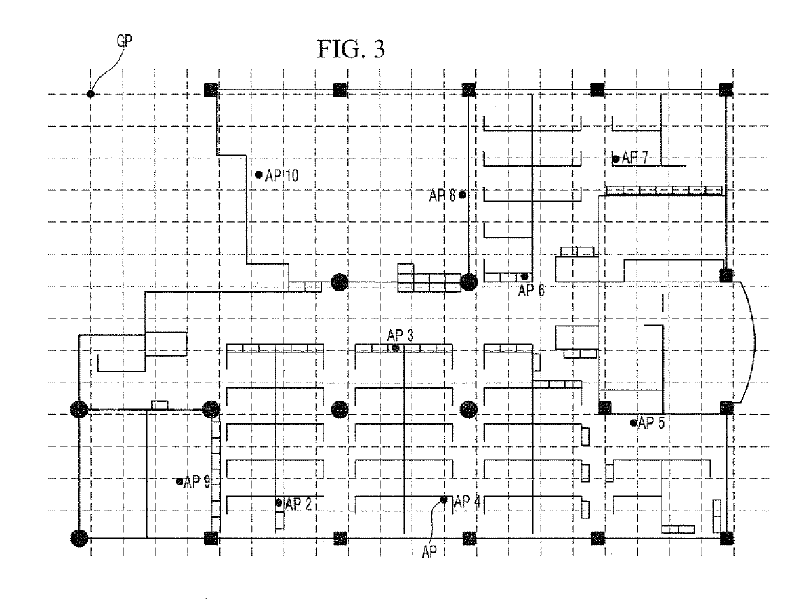

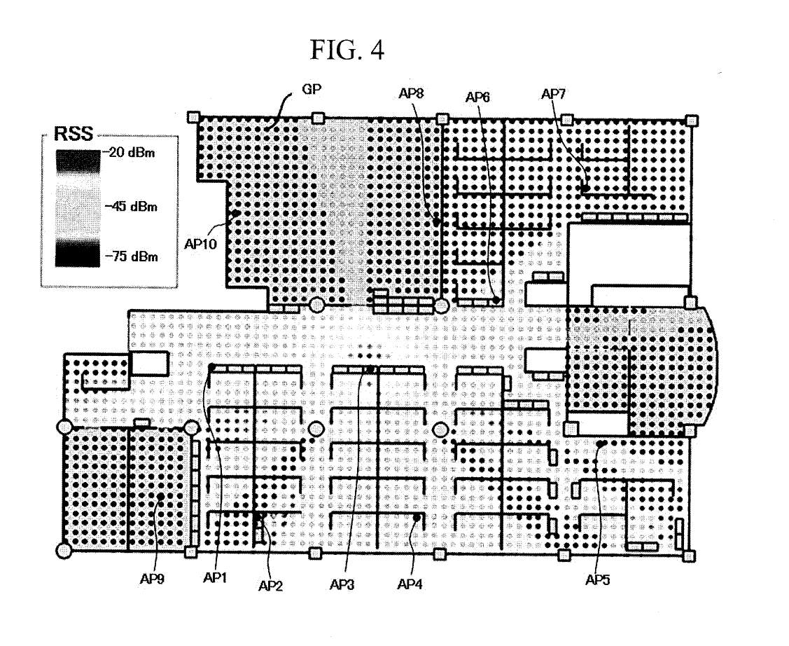

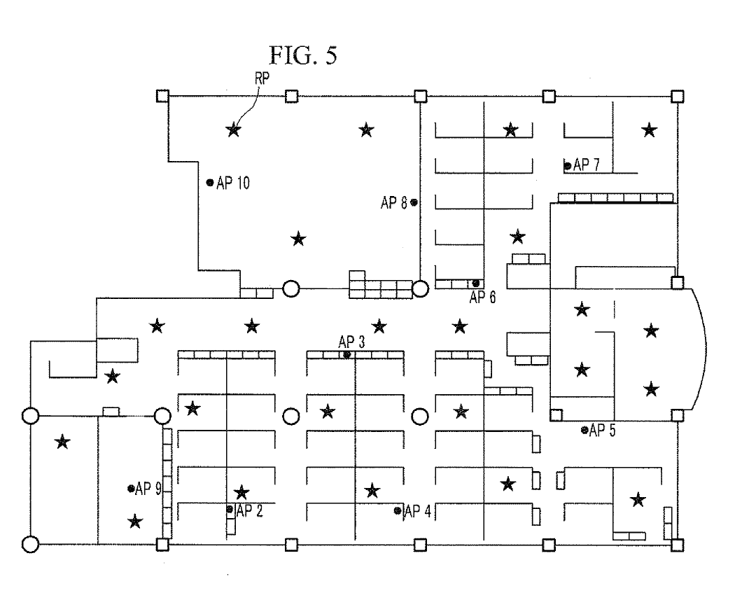

FIG. 2 shows a flowchart of a fingerprint DB generating method according to an exemplary embodiment of the present invention, and FIG. 3 shows a numerical map on which a GP and an AP according to an exemplary embodiment of the present invention are set. FIG. 4 shows an example of per-GP signal strength displayed on a numerical map with color according to an exemplary embodiment of the present invention, and FIG. 5 shows an example of an RP according to an exemplary embodiment of the present invention indicated on a numerical map.

Referring to FIG. 2, the fingerprint DB generating device 100 sets the GP and disposes the AP on the numerical map for showing the real space in the file form through the AP and GP establisher 101 as shown in FIG. 3 (S101). The fingerprint DB generating device 100 uses the AP and GP's position coordinates and radio wave attenuation model to estimate the signal strength of the signal received from the AP for each GP through the signal strength DB generator 102 and generate a signal strength DB (S102). FIG. 4 shows the per-GP signal strength estimated by the signal strength DB generator 102 displayed with color on the numerical map, showing different colors of the GP's according to the signal strength.

Also, the fingerprint DB generating device 100 acquires the actual survey signal strength that is actually surveyed in the real space through the actual survey data acquirer 103 (S103). Here, in the exemplary embodiment of the present invention, as shown in FIG. 5, the RP's (depicted as stars in FIG. 5) for measuring the actual survey signal strength are disposed in the real space.

Upon acquisition of the actual survey signal strength, the fingerprint DB generating device 100 uses the actual survey signal strength to compute the simulation error and generate an error DB (S104). The fingerprint DB generating device 100 uses the computed simulation error to correct the per-GP signal strength estimated by the AP and GP establisher 101 and generate a final fingerprint DB (S105).

According to an embodiment of the present invention, it is possible to generate a fingerprint database with the minimum actual survey data and software-based simulation to thus minimize the difficulty generated during the acquisition of the actual survey data. Further, it is possible to easily generate a new fingerprint database when the configuration of a room is changed.

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A fingerprint database generating device for wireless location, comprising:
a signal strength database generator for estimating signal strength of a signal received from at least one access point disposed on a numerical map for each grid point;
an actual survey data acquirer for acquiring actual survey signal strength measured from at least one point of a real space corresponding to the numerical map;
an error database generator for computing a simulation error by using the actual survey signal strength; and
an error corrector for generating a fingerprint database by correcting the signal strength estimated per grid point by using the simulation error.

2. The fingerprint database generating device of claim 1, further comprising
an access point and grid point establisher for establishing the grid point and disposing the at least one access point on the numerical map.

3. The fingerprint database generating device of claim 2, wherein
the access point and grid point establisher, the signal strength database generator, the error database generator, and the error corrector are realized based on software.

4. The fingerprint database generating device of claim 1, wherein
the numerical map has a storing, readable, and writable file form.

5. The fingerprint database generating device of claim 4, wherein
the signal strength estimated per grid point is estimated based on the position coordinates of the at least one access point, the position coordinates per grid point, and a radio wave attenuation model.

6. A fingerprint database generating method for wireless location, comprising:
setting a plurality of grid points on a numerical map corresponding to a real space for performing wireless location, and disposing at least one access point on the numerical map;
estimating signal strength of the signal received from the at least one access point for each of the plurality of grid points;
acquiring actual survey signal strength measured from at least one point of the real space corresponding to the numerical map;
computing a simulation error by using the actual survey signal strength; and
correcting the signal strength estimated per each of the plurality of grid points by using the simulation error.

7. The fingerprint database generating method of claim 6, wherein
the estimating includes
estimating signal strength for each of the plurality of grid points by using the position coordinates of the at least one access point, the position coordinates for each of the plurality of grid points, and the radio wave attenuation model.

8. The fingerprint database generating method of claim 6, wherein
the acquiring includes
disposing a plurality of points for measuring signal strength in the real space, and
acquiring the actual survey signal strength measured by using wireless signal measurement equipment or access point signal scanning software at the plurality of points.

9. The fingerprint database generating method of claim 8, wherein
the disposing includes
disposing the plurality of points so that the plurality of points may be disposed in the real space.
